(19) United States
(12) Patent Application Publication
(10) Pub. No.: US 2021/0029552 A1
(43) Pub. Date: Jan. 28, 2021

(54) RECEPTION APPARATUS, TRANSMISSION APPARATUS AND RADIO COMMUNICATION METHOD

(71) Applicant: NTT DOCOMO, INC., Tokyo (JP)

(72) Inventors: Daisuke Murayama, Tokyo (JP); Hiroki Harada, Tokyo (JP); Kazuaki Takeda, Tokyo (JP); Satoshi Nagata, Tokyo (JP)

(73) Assignee: NTT DOCOMO, INC., Tokyo (JP)

(21) Appl. No.: 17/042,566

(22) PCT Filed: Mar. 29, 2018
(86) PCT No.: PCT/JP2018/013314

§ 371 Date: Sep. 28, 2020

(51) Int. Cl. H04W 16/14; H04W 72/04

(52) U.S. Cl. CPC H04W 16/14; H04W 72/0453

(57) ABSTRACT

A reception apparatus includes: a receiving section that receives a plurality of request signals that have been transmitted by respectively using a plurality of precoding based on a listening result of a first frequency range; a transmitting section that transmits a response signal that is based on received quality of the plurality of request signals; and a control section that controls reception of data transmitted in the first frequency range by using precoding determined based on the response signal among the plurality of precoding.

### TECHNICAL FIELD

The present invention relates to a reception apparatus, a transmission apparatus and a radio communication method of a next-generation mobile communication system.

### BACKGROUND ART

In Universal Mobile Telecommunications System (UMTS) networks, for the purpose of higher data rates and lower latency, Long Term Evolution (LTE) has been specified (Non-Patent Literature 1). Furthermore, for the purpose of wider bands and a higher speed than those of LTE, LTE successor systems (also referred to as, for example, LTE-Advanced (LTE-A), Future Radio Access (FRA), 4G, 5G, 5G+ (plus), New RAT (NR), 3^{rd} Generation Partnership Project (3GPP) and LTE Rel. 14, 15 and 16˜) are also studied.

Legacy LTE systems (e.g., Rel. 8 to 12) have been specified assuming that exclusive operations are performed in frequency bands (also referred to as, for example, licensed bands, licensed carriers or licensed Component Carriers (CCs)) licensed to telecommunications carriers (operators). For example, 800 MHz, 1.7 GHz and 2 GHz are used as the licensed CCs.

Furthermore, to expand a frequency band, the legacy LTE system (e.g., Rel. 13) supports use of a different frequency band (also referred to as an unlicensed band, an unlicensed carrier or an unlicensed CC) from the above licensed bands. A 2.4 GHz band and a 5 GHz band at which, for example, Wi-Fi (registered trademark) and Bluetooth (registered trademark) can be used are assumed as the unlicensed bands.

More specifically, Rel. 13 supports Carrier Aggregation (CA) that aggregates a carrier (CC) of a licensed band and a carrier (CC) of an unlicensed band. Thus, communication that is performed by using an unlicensed band together with a licensed band will be referred to as License-Assisted Access (LAA).

Use of LAA is studied for future radio communication systems (e.g., 5G, 5G+, NR and Rel. 15 and subsequent releases). In the future, Dual Connectivity (DC) of a licensed band and an unlicensed band, and Stand-Alone (SA) of an unlicensed band are also likely to become targets for which LAA will be studied.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

According to future LAA systems (e.g., 5G, 5G+, NR, Rel. 15 and subsequent releases), before transmitting data in an unlicensed band, a transmission apparatus (e.g., a radio base station on Downlink (DL) and a user terminal on Uplink (UL)) performs listening (also referred to as, for example, LBT: Listen Before Talk, CCA: Clear Channel Assessment, carrier sense or a channel access procedure) for confirming whether or not another apparatus (e.g., a radio base station, a user terminal or a Wi-Fi apparatus) performs transmission.

Furthermore, the transmission apparatus starts data transmission a given duration after (immediately after or a backoff duration after) detecting by the listening that another apparatus does not perform transmission (idle state). Furthermore, it is also assumed that the transmission apparatus transmits a signal by using beam forming.

However, even when the transmission apparatus transmits the data according to a result of the listening (detection of the idle state), there is a risk that it is not possible to appropriately avoid collision of the data. Furthermore, unless an appropriate beam is used, there is a risk that a throughput and communication quality deteriorate.

The present invention has been made in light of this point, and one of objects of the present invention is to provide a reception apparatus, a transmission apparatus and a radio communication method that can improve an avoidance rate of collision of data transmitted according to a listening result.

### Solution to Problem

A reception apparatus according to one aspect of the present invention includes: a receiving section that receives a plurality of transmission request signals that have been transmitted by respectively using a plurality of precoding based on a listening result of a first frequency range; a transmitting section that transmits a response signal that is based on received quality of the plurality of transmission request signals; and a control section that controls reception of data transmitted in the first frequency range by using precoding determined based on the response signal among the plurality of precoding.

### Advantageous Effects of Invention

According to the present invention, it is possible to improve an avoidance rate of collision of data transmitted according to a listening result.

### BRIEF DESCRIPTION OF DRAWINGS

FIG. 1 is a diagram illustrating one example of data collision between hidden terminals.

FIG. 2 is a diagram illustrating one example of CSMA/CA with an RTS/CTS.

FIGS. 3A and 3B are diagrams illustrating one example of collision control of downlink data.

FIG. 4 is a diagram illustrating one example of SLS.

FIGS. 5A and 5B are diagrams illustrating one example of collision control of downlink data according to a first aspect.

FIGS. 6A and 6B are diagrams illustrating one example of a starting point of an SIFS according to the first aspect.

FIGS. 7A to 7C are diagrams illustrating one example of an RTS format according to the first aspect.

FIGS. 8A and 8B are diagrams illustrating one example of an RTS response format according to the first aspect.

FIGS. 9A and 9B are diagrams illustrating another example of an operation in a case where reception of an RTS response signal is not finished within an SIFS.

FIG. 10 is a diagram illustrating another example of an operation in a case where reception of the RTS response signal is not finished within the SIFS.

FIG. 11 is a diagram illustrating one example of a schematic configuration of a radio communication system according to the present embodiment.

FIG. 12 is a diagram illustrating one example of a function configuration of a radio base station according to the present embodiment.

FIG. 13 is a diagram illustrating one example of a function configuration of a baseband signal processing section of the radio base station according to the present embodiment.

FIG. 14 is a diagram illustrating one example of a function configuration of the user terminal according to the present embodiment.

FIG. 15 is a diagram illustrating one example of a function configuration of a baseband signal processing section of the user terminal according to the present embodiment.

FIG. 16 is a diagram illustrating one example of hardware configurations of the radio base station and the user terminal according to the present embodiment.

### DESCRIPTION OF EMBODIMENTS

A plurality of systems such as a Wi-Fi system and a system (LAA system) that supports LAA are assumed to coexist in unlicensed bands (e.g., a 2.4 GHz band and a 5 GHz band). Therefore, it is supposed that it is necessary to avoid collision of transmission and/or control an interference between a plurality of these systems.

For example, the Wi-Fi system that uses the unlicensed band adopts Carrier Sense Multiple Access (CSMA)/Collision Avoidance (CA) for a purpose of collision avoidance and/or interference control. According to CSMA/CA, a given time (DIFS: Distributed access Inter Frame Space) is provided before transmission, and a transmission apparatus confirms (carrier-senses) that there is not another transmission signal, and then transmits data. Furthermore, after transmitting the data, the transmission apparatus waits for ACKnowledgement (ACK) from a reception apparatus. When the transmission apparatus cannot receive the ACK within the given time, the transmission apparatus decides that collision has occurred, and retransmits the data.

Furthermore, for the purpose of collision avoidance and/or interference control, the Wi-Fi system adopts an RTS/CTS for transmitting a transmission request (RTS: Request to Send) before transmission, and making a response as Clear To Send (CTS) when the reception apparatus can perform reception. For example, the RTS/CTS are effective to avoid data collision between hidden terminals.

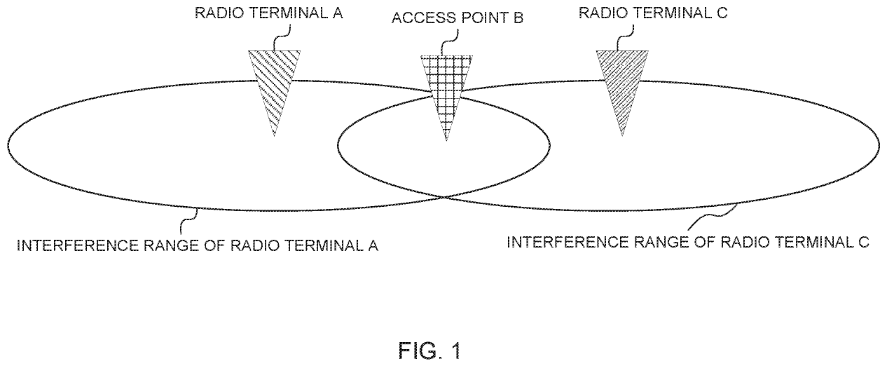

FIG. 1 is a diagram illustrating one example of data collision between hidden terminals. In FIG. 1, a radio wave of a radio terminal C does not reach a radio terminal A, and therefore even if the radio terminal A performs carrier sensing before transmission, the radio terminal A cannot detect a transmission signal from the radio terminal C. As a result, it is assumed that, even while the radio terminal C is transmitting the transmission signal to an access point B, the radio terminal A also transmits a transmission signal to the access point B. In this case, there is a risk that the transmission signals from the radio terminals A and C collide at the access point B, and a throughput lowers.

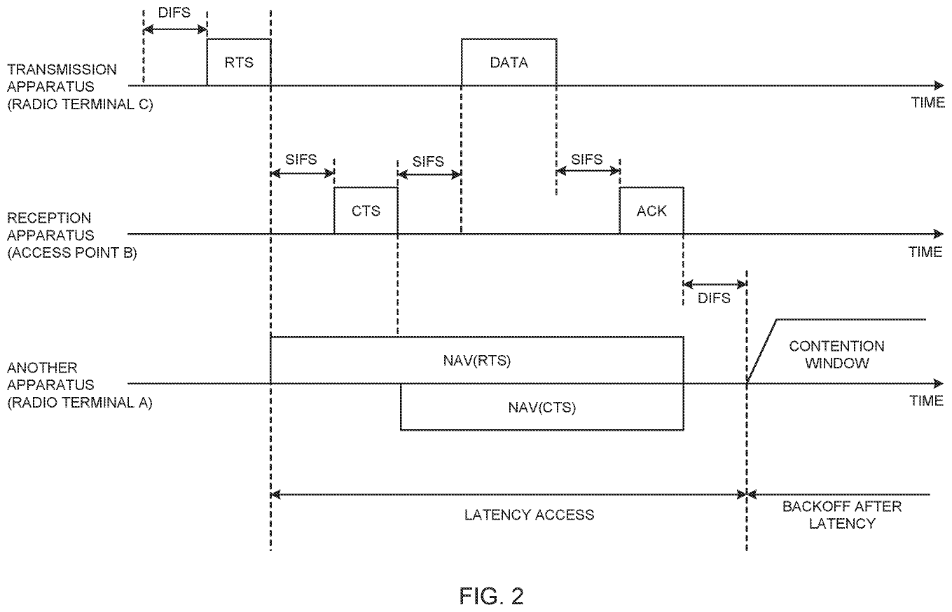

FIG. 2 is a diagram illustrating one example of CSMA/CA with an RTS/CTS. As illustrated in FIG. 2, when confirming that there is not another transmission signal in a given time (DIFS) before transmission, the radio terminal C (transmission side) transmits an RTS (in this regard, the RTS does not reach the radio terminal A (another terminal) in FIG. 1). When receiving the RTS from the radio terminal C, the access point B (reception side) transmits CTS after the given time (SIFS: Short Inter Frame Space).

In FIG. 2, the CTS from the access point B reaches the radio terminal A (another apparatus), too, and therefore the radio terminal A senses that communication is performed, and postpones transmission. A given duration (also referred to as, for example, an NAV: Network Allocation Vector or a transmission forbidden duration) is indicated in an RTS/CTS packet, and therefore communication is suspended during the given duration.

When confirming that there is not another transmission signal in the given duration (SIFS) before transmission, the radio terminal C that has received the CTS from the access point B transmits data (frame) after the given duration (SIFS). The access point B that has received the data transmits ACK after the given duration (SIFS).

In FIG. 2, when detecting the CTS from the access point B, the radio terminal A that is the hidden terminal for the radio terminal C postpones transmission, so that it is possible to avoid collision of the transmission signals of the radio terminals A and C at the access point B.

By the way, according to LAA of a legacy LTE system (e.g., Rel. 13), before transmitting data in an unlicensed band, a transmission apparatus of data performs listening (also referred to as, for example, LBT, CCA, carrier sense or a channel access procedure) for confirming whether or not another apparatus (e.g., a radio base station, a user terminal or a Wi-Fi apparatus) performs transmission.

The transmission apparatus may be, for example, a radio base station (e.g., gNB: gNodeB) on Downlink (DL), and a user terminal (e.g., UE: User Equipment) on Uplink (UL). Furthermore, the reception apparatus that receives data from the transmission apparatus may be, for example, a user terminal on DL and a radio base station on UL.

According to LAA of the legacy LTE system, the transmission apparatus starts data transmission a given duration after (immediately after or a backoff duration after) detecting by the listening that another apparatus does not perform transmission (idle state). However, even when the transmission apparatus transmits the data based on a result of the listening, there are the above hidden terminals and, as a result, there is a risk that it is not possible to avoid data collision in a reception apparatus.

Hence, it is also studied for a future LAA system (also referred to as, for example, Rel. 15 and subsequent releases, 5G, 5G+ or NR) to support collision control based on an RTS/CTS introduced to the Wi-Fi system to improve an avoidance rate of data collision in a carrier of an unlicensed band (also referred to as, for example, an unlicensed CC or an LAA SCell: LAA Secondary Cell). More specifically, collision control in following (1) to (3) is studied.

(1) Similar to the above-described RTS/CTS (FIG. 2), the transmission apparatus that transmits data for the reception apparatus transmits an RTS by using an unlicensed CC, the reception apparatus transmits an RTS response signal by using the unlicensed CC, and the transmission apparatus that has detected the RTS response signal transmits data by using the unlicensed CC.

(2) The transmission apparatus that transmits data for the reception apparatus transmits an RTS by using an unlicensed CC, the reception apparatus transmits an RTS response signal by using the licensed CC, and the transmission apparatus that has detected the RTS response signal transmits data by using the unlicensed CC.

(3) The transmission apparatus that transmits data for the reception apparatus transmits an RTS by using a licensed CC, the reception apparatus transmits an RTS response signal by using the licensed CC, and the transmission apparatus that has detected the RTS response signal transmits data by using the unlicensed CC.

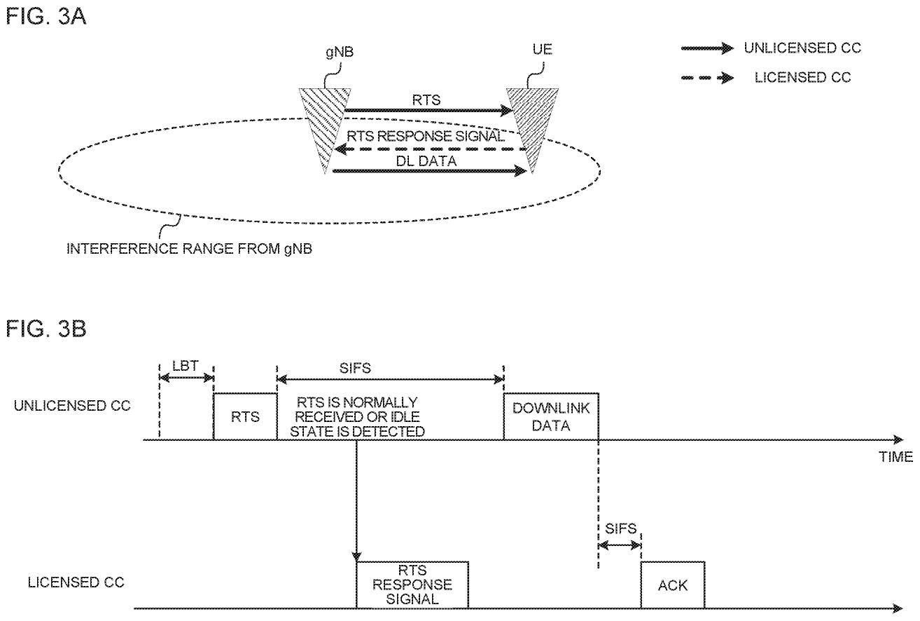

FIGS. 3A and 3B are diagrams illustrating one example of collision control of downlink data in above (2). FIG. 3A illustrates signals that are transmitted and received by using the unlicensed CC and the licensed CC between the radio base station (gNB) and the user terminal (UE). FIG. 3B illustrates signals that are transmitted and received in the unlicensed CC and the licensed CC in time series.

For example, as illustrated in FIG. 3B, in the unlicensed CC, the radio base station performs listening (carrier sensing) in a given duration (referred to as, for example, LBT or a DIFS) before transmission, and transmits an RTS when the unlicensed CC is in an idle state. The given duration will be also referred to as, for example, an LBT duration, a listening duration or a carrier sensing duration, and may include a backoff duration.

In the unlicensed CC, the user terminal performs listening (carrier sensing) when normally receiving the RTS addressed to the own terminal or in a given duration (SIFS) before transmission, and transmits a response signal (RTS response signal) for the RTS by using the licensed CC when the unlicensed CC is in the idle state. The given duration will be also referred to as, for example, an LBT duration, a listening duration or a carrier sensing duration, and may be shorter than the above DIFS. In addition, the carrier sensing may be performed after the RTS addressed to the own terminal is normally received.

The RTS response signal may be a signal that substitutes the above CTS (FIG. 2) or may be the above CTS. The RTS response signal may be referred to as a signal (transmission permission signal) for permitting transmission of downlink data, or a signal (clear-to-send signal) for giving notification that the downlink data can be received.

When receiving the RTS response signal in the licensed CC, the radio base station transmits downlink data in the unlicensed CC within a given duration (SIFS) from transmission of the RTS. The downlink data (the frame for the downlink data) may be transmitted by using a downlink shared channel (e.g., PDSCH: Physical Downlink Shared Channel).

When succeeding in decoding the downlink data transmitted in the unlicensed CC, the user terminal may transmit ACK by using the licensed CC after the given duration (SIFS).

When the user terminal transmits the RTS response signal by using the licensed CC as illustrated in FIGS. 3A and 3B, it is possible to increase an avoidance rate of data collision between hidden terminals. Furthermore, compared to a case where the RTS response signal (e.g., the CTS in FIG. 2) transmitted by using the unlicensed CC is transmitted, it is possible to reduce an interference caused against coexisting other systems in an unlicensed band.

In addition, although the case where the radio base station transmits downlink data by using the unlicensed CC has been described as one example with reference to FIGS. 3A and 3B. However, even in a case where the user terminal transmits uplink data by using the unlicensed CC, the radio base station and the user terminal in FIGS. 3A and 3B can be switched and applied as appropriate.

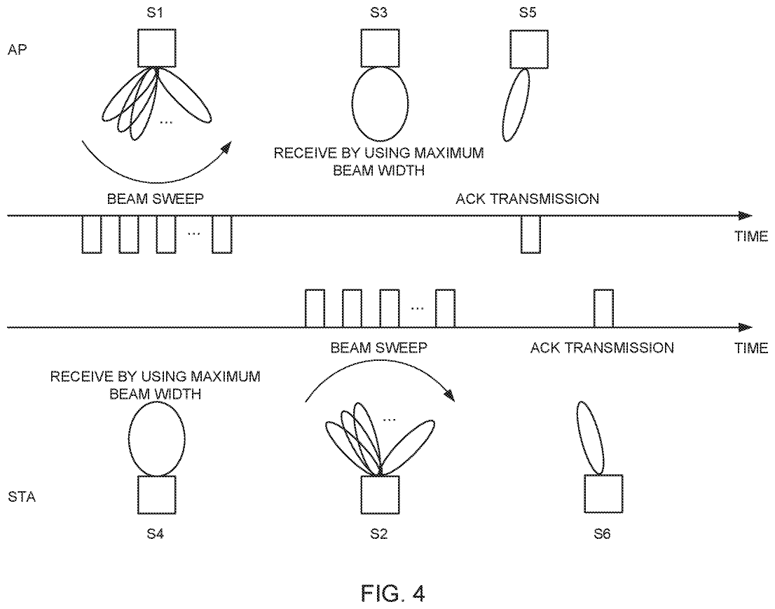

By the way, the legacy Wi-Fi system selects a beam used for transmission and reception by using Sector Level Sweep (SLS). As illustrated in, for example, FIG. 4, the SLS includes following procedures S1 to S6.

(S1) An Access Point (an AP or a Transmission and Reception Point (TRP)) transmits a beacon signal (pilot signal) while switching a plurality of beams (by beam sweeping). The AP may repeat beam sweeping on a regular basis. (S2) By being triggered by the procedure (1), a terminal (a Station: STA or a UE) also transmits a pilot signal by beam sweeping likewise. The STA may repeat beam sweeping on a regular basis. (S3 and S5) The AP receives a pilot signal by using a widest beam (omni), measures a Signal to Noise Ratio (SN ratio: SNR) per beam, feeds back a measurement result (ACK) to the STA, and thereby determines a transmission/reception beam. (S4 and S6) The STA receives the pilot signal by using the widest beam (omni), measures the SN ratio per beam, feeds back the measurement result (ACK) to the AP, and thereby determines the transmission/reception beam.

When the STA does not support transmission Beam Forming (BF) or selects a beam of only DL, the procedures S2 and S3 are unnecessary.

On the other hand, a beam selection scheme according to LAA is not determined. Furthermore, which beam is used when a signal that plays a role equivalent to an RTS is transmitted in a case of unlicensed band transmission according to NR is not determined.

Hence, the inventors of the present invention have studied a beam selection method according to LAA, and reached the present invention.

The present embodiment will be described in detail below with reference to the accompanying drawings. In the present embodiment, the unlicensed CC may be read as, for example, a carrier (a cell or a CC) of a first frequency range, a carrier (a cell or a CC) of the unlicensed band (unlicensed spectrum), an LAA SCell, an LAA cell or a Secondary Cell (SCell). Furthermore, the licensed CC may be read as, for example, a carrier (a cell or a CC) of a second frequency range, a carrier (a cell or a CC) of the licensed band (licensed spectrum), a Primary Cell (PCell) or an SCell.

Furthermore, in the present embodiment, the unlicensed CC may be LTE-based, or may be NR-based (NR unlicensed CC). Similarly, the licensed CC may be also LTE-based or may be NR-based. In an LAA system (radio communication system) according to the present embodiment, the unlicensed CC and the licensed CC may be subjected to Carrier Aggregation (CA) or Dual Connectivity (DC) in any one system of LTE and NR (stand-alone) or may be subjected to CA or DC between LTE and NR systems (non-stand-alone).

Furthermore, in the present embodiment, a beam may be read as, for example, precoding (a precoding matrix or a Precoding Matrix Indicator (PMI)) or a spatial resource.

Furthermore, the collision control in above (2) will be exemplified below. However, the present embodiment is applicable to the collision control in any one of above (1) to (3), too. That is, an RTS according to the present embodiment may be transmitted in any one of the unlicensed CC and the licensed CC. Similarly, an RTS response signal may be also transmitted in any one of the unlicensed CC and the licensed CC.

(First Aspect)

The first aspect will describe collision control during downlink data transmission. According to the first aspect, a transmission apparatus is a radio base station (e.g., a gNB, a Transmission and Reception Point (TRP) or a transmission point), and a reception apparatus is a user terminal (e.g., UE).

In the first aspect, the transmission apparatus transmits an RTS by using each of a plurality of beams. The reception apparatus transmits a signal (RTS response signal) corresponding to CTS in a licensed band. The RTS response signal gives notification of information related to a beam (beam information) from the reception apparatus to the transmission apparatus.

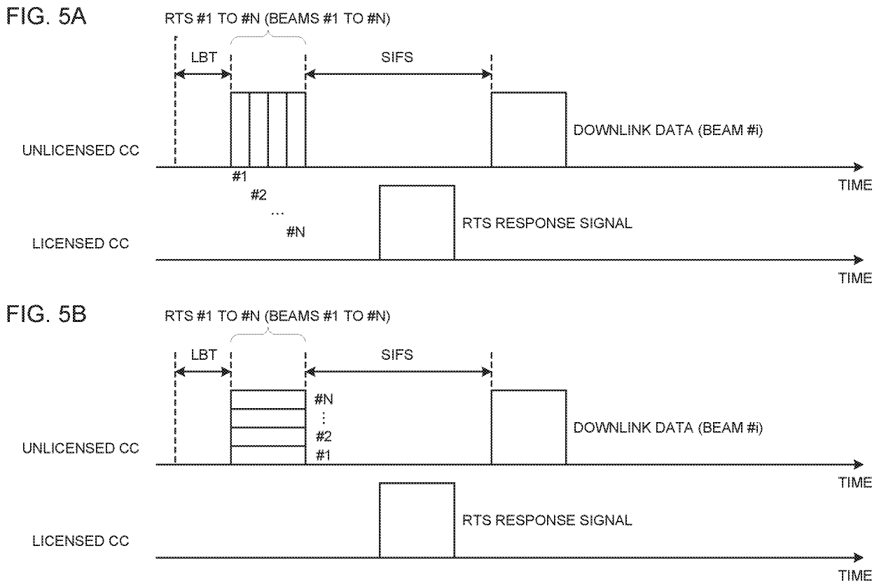

FIGS. 5A and 5B are diagrams illustrating one example of collision control of downlink data according to the first aspect. These FIGS. 5A and 5B illustrate the signals that are transmitted and received in the unlicensed CC and the licensed CC in time series. FIG. 5A illustrates a case where a plurality of RTSs that respectively use a plurality of beams are subjected to time division multiplexing. FIG. 5B illustrates a case where a plurality of RTSs that respectively use a plurality of beams are subjected to frequency division multiplexing.

As illustrated in FIGS. 5A and 5B, the beam selection method may include following procedures.

(1) When detecting an idle state in an unlicensed CC by listening (carrier sensing) over a given duration (LBT or a DIFS) before transmission, a radio base station (TRP) transmits an RTS by using each of a plurality of beams. The given duration will be also referred to as, for example, an LBT duration, a listening duration or a carrier sensing duration, and may include a backoff duration. When, for example, detecting the idle state by listening over the given duration before transmission, and, furthermore, when detecting the idle state by listening after a backoff time passes, the radio base station may transmit RTSs (RTSs #1, #2, . . . and #N) by respectively using a plurality of beams (beams #1, #2, . . . and #N).

The RTS that is transmitted by using each beam may include a beam used for the RTS, and at least one identifier (identification information) of the RTS. The identifier may be at least one of, for example, an identifier of the RTS (an RTS identifier or an RTS number), an identifier of the beam (a beam identifier or a beam number), and information associated with the beam.

The RTS may be an RTS of a Wi-Fi system (FIG. 2) or a signal that complies with IEEE802.11 or may be a unique signal. The RTS may be a signal (transmission request signal) for requesting transmission of a downlink signal, or a signal (transmission notification signal) for giving notification of transmission of the downlink signal.

In addition, the radio base station may transmit the RTS in the licensed CC.

(2) When normally receiving an RTS, a user terminal (UE) transmits an RTS response signal including beam information in a licensed CC. The beam information may indicate a beam (beam #i) having the highest received quality among at least one received beam, or may indicate an RTS (RTS #i) associated with the beam. Furthermore, the beam information may indicate received quality of at least one received beam. The received quality may be at least one of Reference Signal Received Power (RSRP), Reference Signal Received Quality (RSRQ), a Signal to Interference plus Noise Ratio (SINR), and a Signal to Noise Ratio (SNR).

In this regard, the user terminal normally receives an RTS addressed to the own terminal, and performs listening (carrier sensing) in an unlicensed CC in a given duration (also referred to as, for example, an LBT duration, a listening duration, a carrier sensing duration or an SIFS) before transmission, and transmits a response signal (RTS response signal) for the RTS by using the licensed CC in a case where the unlicensed CC is in the idle state. In addition, the listening may be performed after the RTS is normally received, or before the RTS is received.

The RTS response signal is a signal that substitutes the above CTS (FIG. 2). The RTS response signal may be referred to as a signal (transmission permission signal) for permitting transmission of downlink data, or a signal (clear-to-send signal) for giving notification that the downlink data can be received.

The RTS response signal may include a field (e.g., TA: Transmitter Address) that indicates a transmission source. An identifier of a user terminal (a UE number or a UE ID) that transmits the RTS response signal may be stored in the field. Consequently, the radio base station can recognize from which user terminal the RTS response signal is received.

Furthermore, the RTS response signal (a frame for the RTS response signal) may be transmitted by using an uplink control channel (e.g., a UE-dedicated PUCCH: Physical Uplink Control Channel) or an uplink shared channel (e.g., PUSCH: Physical Uplink Shared Channel). The PUSCH may be a PUSCH (a PUSCH with a grant or a grant-based PUSCH) that is dynamically scheduled by Downlink Control Information (DCI, a UL grant or a dynamic grant) in the licensed CC, or a PUSCH (a PUSCH without a grant or a grant-free PUSCH) that is semi-statically configured by a higher layer signaling (e.g., an RRC signaling or a configured grant) without scheduling using the UL grant.

The RTS response signal may be scheduled by the PDCCH in the licensed CC such that the RTS response signal is transmitted by a time equal to or less than the SIFS after RTS transmission.

The radio base station may receive the RTS response signal by using a wider beam (e.g., the widest beam or omni-directional beam) than that of data transmission.

In addition, the user terminal may transmit the RTS response signal in the unlicensed CC.

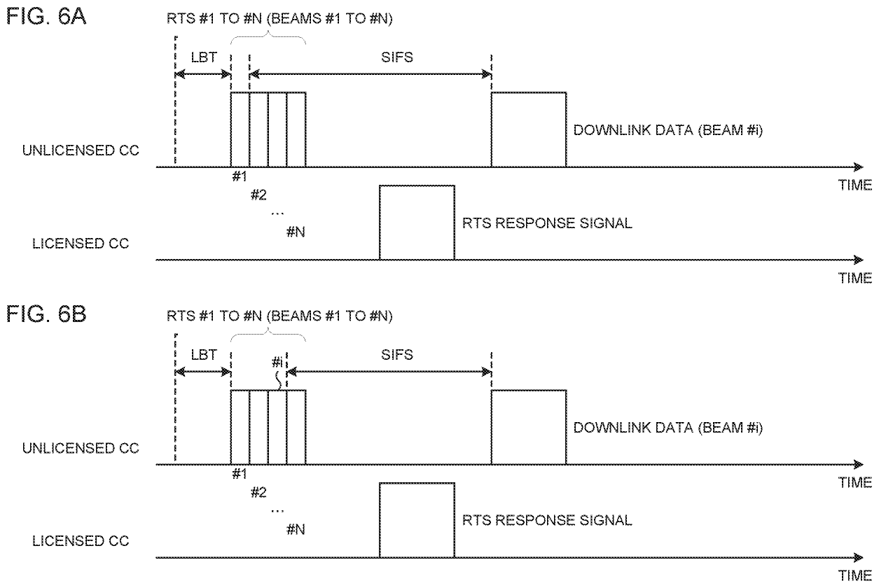

(3) When an interval equal to or less than the SIFS passes from a given timing of RTS transmission after the radio base station confirms reception of the RTS response signal, the radio base station transmits data by using a beam (beam #i) based on the RTS response signal. The given timing (a starting point of the SIFS) may be an end time of RTS transmission associated with all beams (beams #1 to #N) as illustrated in FIG. 5A. Furthermore, the given timing may be a transmission end time of an RTS associated with a first beam (beam #1) as illustrated in FIG. 6A. Furthermore, the given timing may be a transmission end time of an RTS associated with a beam (beam #i) used for data transmission as illustrated in FIG. 6B. A beam used for transmission of the data may be one beam indicated by the RTS response signal. The beam used for transmission of the data may be a beam associated with the highest received quality among at least one received quality indicated by the RTS response signal.

Furthermore, the RTS may be transmitted in a bandwidth that can be detected by other systems (e.g., the Wi-Fi system or IEEE802.11) or a bandwidth that cannot be detected by the other systems. Similarly, according to a reception result of the RTS response signal, downlink data may be transmitted in the bandwidth that can be detected by the other systems or the bandwidth that cannot be detected by the other systems.

When the RTS is transmitted in the bandwidth (e.g., a transmission bandwidth wider than those of RTSs of the other systems) that cannot be detected by the above other systems, only the LAA system can receive the RTS and/or the downlink data, and perform collision control closed for the LAA system.

On the other hand, when the RTS is transmitted in the bandwidth (e.g., at least part of the transmission bandwidths of the RTSs of the other systems) that can be detected by the other systems, too, and the RTS is transmitted in a format that complies with the other systems, it is possible to perform transverse collision avoidance control not only in the LAA system but also between the LAA system and other systems that coexist in the unlicensed band.

Furthermore, a plurality of RTSs may be multiplexed in at least one of a frequency domain, a time domain and a spatial domain, and transmitted. Each of a plurality of these RTSs may be transmitted in the bandwidth that can be detected by the other systems. When a plurality of above RTSs are subjected to frequency multiplexing, items of downlink data are transmitted in a total transmission bandwidth of a plurality of the RTSs, so that it is possible to maintain a throughput of the items of downlink data in the LAA system. Furthermore, a plurality of the RTSs may be multiplexed in the spatial domain, and transmitted by different beams.

In addition, in a case where the radio base station does not detect the RTS response signal within the given duration (SIFS) after transmission of the RTSs, the radio base station may stop transmission of downlink data.

When the user terminal can perform beam forming, the user terminal may perform at least one of reception of an RTS, transmission of an RTS response signal and reception of downlink data by using a wide beam (e.g., the widest beam or omni-directional (omni) beam).

The user terminal may perform beam forming. The radio base station may repeat transmission of a plurality of RTSs that respectively use a plurality of transmission beams at a given periodicity. The number of times of repetition may be equal to or more than the number of reception beams that the user terminal can use. While switching a reception beam per periodicity, the user terminal may measure received quality of the RTS, and determine the reception beam associated with the best received quality as a use beam. The user terminal may transmit the RTS response signal by using a use beam. The RTS response signal may include identification information of an RTS (or a transmission beam) associated with the best received quality among a plurality of RTSs (a plurality of transmission beams) received by using the use beam or may include received quality of each of a plurality of RTSs (a plurality of transmission beams) received by using the use beam. The user terminal may receive downlink data by using the use beam.

<RTS Format>

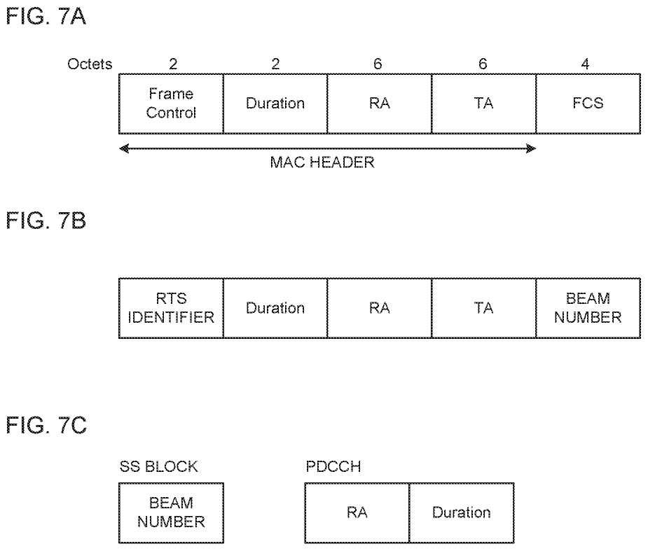

FIGS. 7A to 7C are diagrams illustrating formats of an RTS (also referred to as, for example, signal formats or frame formats) according to the first aspect.

FIG. 7A illustrates one example of the format of the RTS (RTS format) that complies with the other system (e.g., IEEE802.11). In FIG. 7A, a Duration domain may indicate at least one of a time and a data amount (the number of octets) required for transmission of data.

Furthermore, UE IDs (user terminal identifiers) may be stored (may be included) in a domain (a Receiver Address (RA) domain or an address field) in which a Medium Access Control (MAC) address (or an address of an RTS) of a reception side is stored.

A cell identifier (cell ID) may be stored in a domain (Transmitter Address (TA) domain) (or a transmission source of the RTS) in which an MAC address of a transmission side is stored. Furthermore, identification information related to a beam (beam identification information such as a beam number, a beam identifier or an RTS identifier) used for the RTS may be stored in the TA.

FIG. 7B illustrates another example of the RTS format. The RTS format illustrated in FIG. 7B may not comply with the other system (e.g., IEEE802.11).

The RTS format illustrated in FIG. 7B may include at least one of a domain that indicates the RTS (a domain in which an identifier of the RTS (RTS identifier) is stored), a domain (Duration domain) that indicates at least one of the time and the data amount required for data transmission, a domain (RA domain) that specifies a receiver (address), a domain (TA domain) that specifies a sender (transmission source), and a domain (beam domain) that specifies a beam.

A user terminal identifier (UE ID) may be stored (may be included) in the RA domain in FIG. 7B.

Furthermore, as illustrated in FIG. 7B, the RTS format may include a number (beam number) for identifying a beam for transmitting the RTS. When the RTS addressed to a certain user terminal is transmitted by using a plurality of beams, the certain user terminal may transmit an RTS response signal including a beam number among RTSs of the best received quality.

Furthermore, the RTS format illustrated in FIG. 7B may be DCI that is transmitted on a downlink control channel (e.g., PDCCH: Physical Downlink Control Channel). For example, a PDCCH (DCI or a UL grant) for scheduling a PUSCH may be the above other RTS format. In this case, the user terminal may transmit the RTS response signal by using the PUSCH scheduled by the DCI.

The RTS may be a signal including at least one of an SS block, a CSI-RS signal and a PDCCH.

In this regard, the SS block is a signal block (also referred to as, for example, an SS/PBCH block) including a synchronization signal (also referred to as, for example, a Primary Synchronization Signal (PSS) and/or a Secondary Synchronization Signal (SSS)), and a broadcast channel (also referred to as, for example, a broadcast signal or a Physical Broadcast Channel (PBCH)).

The RTS may include at least one of a domain (RA domain) that specifies a receiver (address), a domain (TA domain) that specifies a sender (transmission source) and a domain (beam domain) that specifies a beam. The RA domain may be included in DCI. The TA domain may be included in an SS block. The beam domain may be substituted by an SS block or a CSI-RS signal. The RTS may further include a domain (Duration domain) indicating at least one of a time and a data amount required for data transmission. The Duration domain may be included in DCI.

For example, as illustrated in FIG. 7C, the RTS may include an SS block and a PDCCH (DCI). The SS block may indicate a resource of the PDCCH (or a Control Resource Set (CORESET) including the PDCCH). The SS block may include a beam domain (beam number). The DCI may include the RA domain and the Duration domain.

The beam domain may be an index (e.g., a number indicating a position in a time domain) of the SS block associated with a beam. Furthermore, the beam domain may be a Channel State Information Reference Signal (CSI-RS) resource indicator (CRI: CSI-Resource Indicator) associated with the beam (a signal related to the beam).

Only beam domains of a plurality of RTSs that are respectively transmitted by using a plurality of beams may be different.

<RTS Transmission Method>

The radio base station transmits RTSs by using a plurality of beams.

For example, as illustrated in FIG. 5A, the radio base station may use different beams in different time resources (beam sweep). In this case, frequency resources in which a plurality of beams are transmitted may be identical.

For example, as illustrated in FIG. 5B, the radio base station may use different beams in different frequency resources. In this case, time resources in which a plurality of beams are transmitted may be identical.

Furthermore, the radio base station may multiplex RTSs that use a plurality of beams in identical time resources and identical frequency resources. To suppress an interference between a plurality of beams, the radio base station may multiplex beams in opposite directions.

<RTS Response Signal Format>

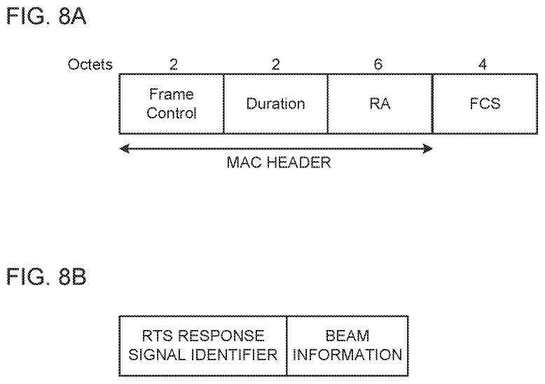

FIGS. 8A and 8B are diagrams illustrating formats of an RTS response signal (also referred to as, for example, signal formats or frame formats) according to the first aspect.

FIG. 8A illustrates one example of a format of the RTS response signal (an RTS response format or a CTS format) that complies with the other system (e.g., IEEE802.11). In FIG. 8A, a Duration domain may indicate at least one of a time and a data amount (the number of octets) required for transmission of the data. A user terminal identifier (UE ID) may be stored in the RA domain in FIG. 8A. The RTS response signal format may further include a Frame Check Sequence (an FCS such as Cyclic Redundancy Check (CRC)). The RTS response signal format may further include information related to a received beam (beam information). The beam information may be included in the RA domain.

FIG. 8B illustrates another example of the RTS response format. The RTS response format illustrated in FIG. 8B may not comply with the other system (e.g., IEEE802.11), and only needs to include at least a domain that indicates an RTS response signal (a domain in which an identifier of an RTS (RTS identifier) is stored), and a domain that indicates the beam information. The RTS response signal format may further include an identifier of a user terminal (UE ID) that is a transmission source.

The beam information may include an identifier of a beam (or an RTS) of the best (highest) received quality (e.g., at least one of RSRP, RSRQ, an SINR and an SNR). In this case, the radio base station may use the beam indicated by the RTS response signal for data transmission. The beam identifier may be an SS block index associated with the beam, or a CRI associated with the beam.

Furthermore, the beam information may include received quality of the RTS of each beam. In this case, the radio base station may select a beam associated with the best received quality of a plurality of received quality included in the RTS response signals, and use the selected beam for data transmission.

Furthermore, the RTS response format may include an identifier of a user terminal (UE ID) that is a transmission source of the RTS response signal.

<Scheduling of RTS Response Signal>

The user terminal may transmit the RTS response signal by using one of (1) a PUSCH that is scheduled by a UL grant, (2) a PUSCH (a PUSCH that is configured by a higher layer signaling or a grant-free PUSCH) without scheduling using the UL grant, and (3) a UE-dedicated PUCCH.

(1) When the PUSCH that is scheduled in above (1) is used, the radio base station may transmit a UL grant for scheduling of a PUSCH in a licensed CC after transmission of the RTS in the unlicensed CC. In addition, the UL grant may be transmitted at the same time at which the RTS is transmitted, may be transmitted after transmission of the RTS, or may be transmitted before transmission of the RTS by taking a processing speed of the user terminal into account.

When normally receiving the RTS or detecting the idle state by listening, the user terminal may transmit the RTS response signal by using the PUSCH that is scheduled by the above UL grant. In addition, the user terminal may start the above listening at a point of time of reception of the above UL grant, or after the RTS is normally received.

Thus, by controlling a transmission timing of the above UL grant, the radio base station can quickly receive the RTS response signal, and start downlink data transmission within a given duration (SIFS) after transmission of the RTS.

On the other hand, when the PUSCH without scheduling in above (2) or the PUCCH in above (3) is used, the radio base station may not transmit the above UL grant.

Furthermore, it is supposed that, when beam sweeping is used for transmission of an RTS, reception of an RTS response signal is not finished within an SIFS after transmission of the RTS.

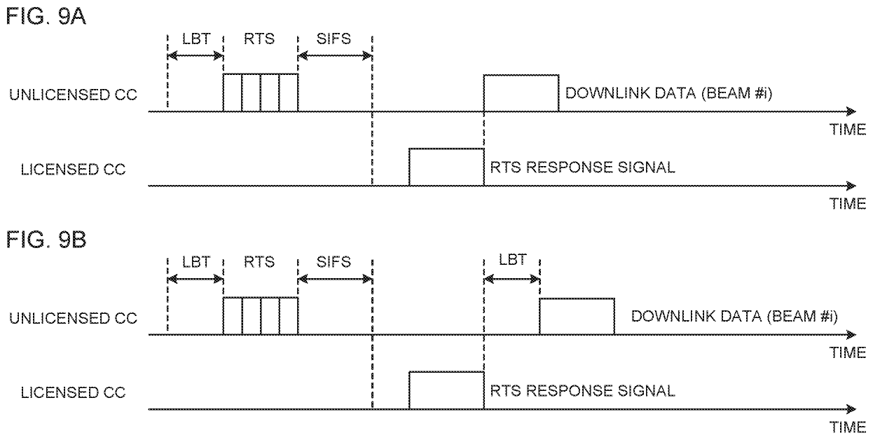

Hence, as illustrated in FIG. 9A, when reception of the RTS response signal is not finished within the SIFS, the radio base station may immediately transmit downlink data after receiving the RTS response signal.

Hence, as illustrated in FIG. 9B, when reception of the RTS response signal is not finished within the SIFS, the radio base station may perform listening (LBT operation) after receiving the RTS response signal, and transmit downlink data when confirming the idle state.

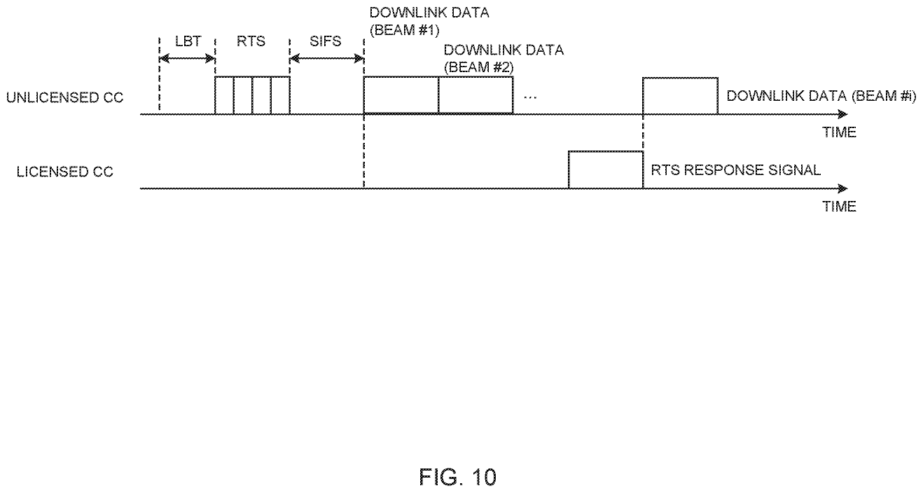

Furthermore, as illustrated in FIG. 10, when reception of the RTS response signal is not finished within the SIFS, the radio base station may transmit items of downlink data by using all beams (a beam #1, a beam #2 and . . . ) without waiting for reception of the RTS response signal, and stop transmission of the items of downlink data that uses beams other than a beam (beam #n) determined based on the RTS response signal when receiving the RTS response signal.

Furthermore, in FIG. 10, a timeout duration (also referred to as a second duration) in which downlink data can be transmitted without receiving the RTS response signal may be provided. The timeout duration may be started from (1) a given timing after the above given duration (also referred to as the SIFS or a first duration), or may be started after (2) transmission of the above RTS. In a case of (2), the timeout duration may have an identical time duration (the first duration and the second duration may be identical) to the above given duration (SIFS), and the downlink data may not be transmitted in this case.

In a case where, for example, the radio base station does not receive the RTS response signals from the user terminals within the given duration (SIFS) after transmission of the RTSs, the radio base station may continue transmission of the items of downlink data using all beams until the timeout duration (e.g., in a case of above (1)) passes even if the RTS response signals are not received. On the other hand, in a case where the RTS response signals are not received even after the timeout duration passes, the radio base station may stop transmission of the items of downlink data, or may stop transmission of the downlink data that uses at least one of all beams. In addition, when the RTS response signals are received within the timeout duration, the radio base station may continue transmission of the items of downlink data that uses the beams determined based on the RTS response signals after the timeout duration, too. By providing this timeout duration, it is possible to prevent an increase in a collision frequency due to transmission of the items of downlink data without the RTS response signal.

The above future LAA system assumes that, when the idle state is detected in the unlicensed CC by listening, there is provided a given duration in which the transmission apparatus (the radio base station on DL and the user terminal on UL) is permitted to perform transmission without performing listening again. The given duration will be also referred to as, for example, a burst duration, a Maximum Channel Occupancy Time (MCOT), a channel occupancy time and a burst transmission duration. Furthermore, the length of the given duration will be also referred to as, for example, a burst length, a maximum burst length, a maximum allowed burst length or a MAX burst length.

The radio base station may multiplex a plurality of items of data or a plurality of RTSs that respectively use a plurality of beams in the burst duration. For example, a plurality of items of data or a plurality of RTSs may be multiplexed in at least one of a time domain (TDM: Time Division Multiplexing), a frequency domain (FDM: Frequency Division Multiplexing), a spatial domain (SDM: Space Division Multiplexing) and a power domain (MUST: Multiuser Superposition Transmission or NOMA: Non-Orthogonal Multiple Access).

<Handling of RTS that is not Addressed to Own Terminal>

When detecting an RTS that is not addressed to the own terminal, the user terminal may ignore the RTS, and may not transmit an RTS response signal.

Alternatively, when detecting the RTS that is not addressed to the own terminal and recognizing start of data transmission for another apparatus, the user terminal may stop transmission during a time indicated by the duration domain of the RTS.

Furthermore, the radio base station may transmit the RTSs by using a plurality of beams to a plurality of user terminals. In this case, the RA domain of the RTS may indicate a plurality of user terminal identifiers (UE IDs) or a user terminal group identifier (group ID) indicating a user terminal group. When receiving the RTS response signal, the radio base station may multiplex a plurality of items of data for a plurality of user terminals in the above burst duration, and transmit these items of data.

The radio base station may determine a beam for each user terminal based on the RTS response signal from each of a plurality of user terminals, and transmit data to each user terminal by using the beam associated with each user terminal.

As described above, according to the first aspect, the transmission apparatus and the reception apparatus can select optimal beams for data transmission. Furthermore, access control corresponding to CSMA/CA with an RTS/CTS is enabled for LAA, so that it is possible to increase an avoidance rate of signal collision between hidden terminals.

(Second Aspect)

The second aspect will describe collision control during uplink data transmission. In the second aspect, a reception apparatus is a radio base station (e.g., a gNB, a Transmission and Reception Point (TRP) or a transmission point), and the transmission apparatus is a user terminal (e.g., UE).

In the second aspect, it suffices to switch the transmission apparatus and the reception apparatus according to the first aspect, and apply the first aspect to the collision control of an uplink data transmission. More specifically, in the second aspect, it suffices to read a “radio base station” according to the first aspect as the “user terminal”, read a “user terminal” according to the first aspect as the “radio base station”, and read “downlink data” as “uplink data”.

Furthermore, in the second aspect, the radio base station may transmit an above RTS response signal by using a downlink control channel (e.g., PDCCH) or a downlink shared channel (e.g., PDSCH).

(Radio Communication System)

The configuration of the radio communication system according to the present embodiment will be described below. This radio communication system is applied the radio communication method according to each of the above aspects. In addition, the radio communication method according to each of the above aspects may be applied alone or may be applied in combination.

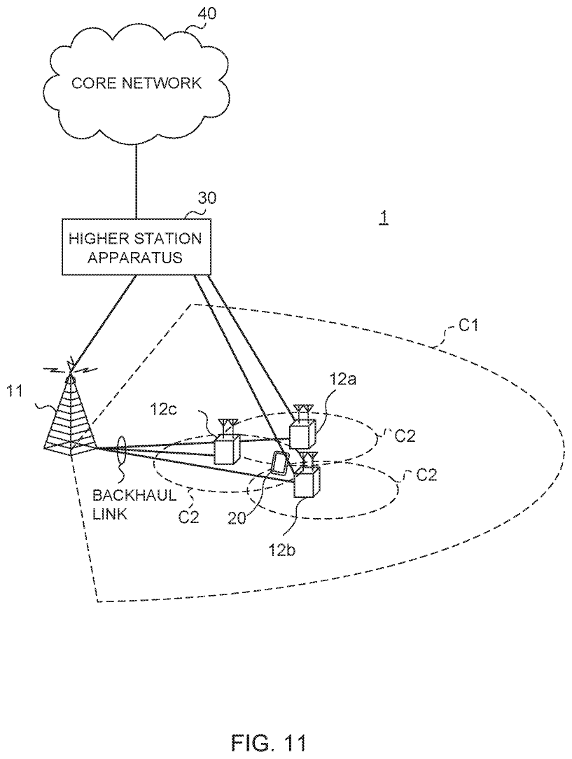

FIG. 11 is a diagram illustrating one example of a schematic configuration of the radio communication system according to the present embodiment. A radio communication system 1 can apply Carrier Aggregation (CA) and/or Dual Connectivity (DC) that aggregate a plurality of base frequency blocks (component carriers) whose 1 unit is a system bandwidth (e.g., 20 MHz) of the LTE system. In this regard, the radio communication system 1 may be referred to as SUPER 3G, LTE-Advanced (LTE-A), IMT-Advanced, 4G, 5G, Future Radio Access (FRA) or New Rat (NR).

The radio communication system 1 illustrated in FIG. 11 includes a radio base station 11 that forms a macro cell C1, and radio base stations 12a to 12c that are located in the macro cell C1 and form small cells C2 narrower than the macro cell C1. Furthermore, a user terminal 20 is located in the macro cell C1 and each small cell C2. Different numerologies may be configured to be applied between cells. In this regard, the numerology refers to a communication parameter set that characterizes a signal design of a certain RAT or an RAT design.

The user terminal 20 can connect with both of the radio base station 11 and the radio base stations 12. The user terminal 20 is assumed to concurrently use the macro cell C1 and the small cells C2 that use different frequencies by CA or DC. Furthermore, the user terminal 20 can apply CA or DC by using a plurality of cells (CCs) (e.g., two CCs or more). Furthermore, the user terminal can use licensed band CCs and unlicensed band CCs as a plurality of cells. In addition, one of a plurality of cells can be configured to include a TDD carrier to which a reduced TTI is applied.

The user terminal 20 and the radio base station 11 can communicate by using a carrier (referred to as a Legacy carrier) of a narrow bandwidth in a relatively low frequency band (e.g., 2 GHz). On the other hand, the user terminal 20 and each radio base station 12 may use a carrier of a wide bandwidth in a relatively high frequency band (e.g., 3.5 GHz, 5 GHz or 30 to 70 GHz) or may use the same carrier as that used between the user terminal 20 and the radio base station 11. In this regard, a configuration of the frequency band used by each radio base station is not limited to this.

The radio base station 11 and each radio base station 12 (or the two radio base stations 12) can be configured to be connected by way of wired connection (e.g., optical fibers compliant with a Common Public Radio Interface (CPRI) or an X2 interface) or radio connection.

The radio base station 11 and each radio base station 12 are each connected with a higher station apparatus 30 and connected with a core network 40 via the higher station apparatus 30. In this regard, the higher station apparatus 30 includes, for example, an access gateway apparatus, a Radio Network Controller (RNC) and a Mobility Management Entity (MME), yet is not limited to these. Furthermore, each radio base station 12 may be connected with the higher station apparatus 30 via the radio base station 11.

In this regard, the radio base station 11 is a radio base station that has a relatively wide coverage, and may be referred to as a macro base station, an aggregate node, an eNodeB (eNB) or a transmission and reception point. Furthermore, each radio base station 12 is a radio base station that has a local coverage, and may be referred to as a small base station, a micro base station, a pico base station, a femto base station, a Home eNodeB (HeNB), a Remote Radio Head (RRH) or a transmission and reception point. The radio base stations 11 and 12 will be collectively referred to as a radio base station 10 below when not distinguished.

Each user terminal 20 is a terminal that supports various communication schemes such as LTE, LTE-A, NR, 5G and 5G+ and may include not only a mobile communication terminal but also a fixed communication terminal.

The radio communication system 1 can apply Orthogonal Frequency-Division Multiple Access (OFDMA) to Downlink (DL) and can apply Single Carrier-Frequency Division Multiple Access (SC-FDMA) to Uplink (UL) as radio access schemes. OFDMA is a multicarrier transmission scheme that divides a frequency band into a plurality of narrow frequency bands (subcarriers) and maps data on each subcarrier to perform communication. SC-FDMA is a single carrier transmission scheme that divides a system bandwidth into bands including one or contiguous resource blocks per terminal and causes a plurality of terminals to use respectively different bands to reduce an inter-terminal interference. In this regard, uplink and downlink radio access schemes are not limited to a combination of these schemes, and OFDMA may be used on UL.

The radio communication system 1 uses a downlink data channel (also referred to as, for example, a PDSCH: Physical Downlink Shared Channel or a downlink shared channel) shared by each user terminal 20, a broadcast channel (PBCH: Physical Broadcast Channel) and an L1/L2 control channel as DL channels. User data, higher layer control information and a System Information Block (SIB) are conveyed on the PDSCH. Furthermore, a Master Information Block (MIB) is conveyed on the PBCH.

The L1/L2 control channel includes a downlink control channel (a Physical Downlink Control Channel (PDCCH) or an Enhanced Physical Downlink Control Channel (EPDCCH)), a Physical Control Format Indicator Channel (PCFICH), and a Physical Hybrid-ARQ Indicator Channel (PHICH). Downlink Control Information (DCI) including scheduling information of the PDSCH and the PUSCH is conveyed on the PDCCH. The number of OFDM symbols used for the PDCCH is conveyed on the PCFICH. Transmission acknowledgement information (ACK/NACK) of an HARQ for the PUSCH is conveyed on the PHICH. The EPDCCH is subjected to frequency division multiplexing with the PDSCH (downlink shared data channel) and is used to convey DCI similar to the PDCCH.

The radio communication system 1 uses an uplink data channel (also referred to as, for example, a PUSCH: Physical Uplink Shared Channel or an uplink shared channel) shared by each user terminal 20, an uplink control channel (PUCCH: Physical Uplink Control Channel), and a random access channel (PRACH: Physical Random Access Channel) as UL channels. User data and higher layer control information are conveyed on the PUSCH. Uplink Control Information (UCI) including at least one of transmission acknowledgement information (ACK/NACK) and radio quality information (CQI) is conveyed on the PUSCH or the PUCCH. A random access preamble for establishing connection with a cell is conveyed on the PRACH.

<Radio Base Station>

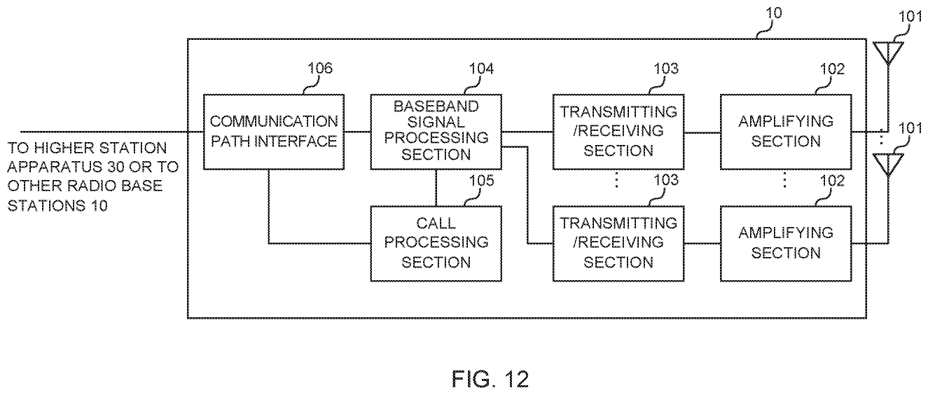

FIG. 12 is a diagram illustrating one example of an overall configuration of the radio base station according to the present embodiment. The radio base station 10 includes pluralities of transmission/reception antennas 101, amplifying sections 102 and transmitting/receiving sections 103, a baseband signal processing section 104, a call processing section 105 and a communication path interface 106. In this regard, the radio base station 10 only needs to be configured to include one or more of each of the transmission/reception antennas 101, the amplifying sections 102 and the transmitting/receiving sections 103. The radio base station 10 is a transmission apparatus of downlink data and a reception apparatus of uplink data.

Downlink data transmitted from the radio base station 10 to the user terminal 20 is input from the higher station apparatus 30 to the baseband signal processing section 104 via the communication path interface 106.

The baseband signal processing section 104 performs processing of a Packet Data Convergence Protocol (PDCP) layer, segmentation and concatenation of the user data, transmission processing of a Radio Link Control (RLC) layer such as RLC retransmission control, Medium Access Control (MAC) retransmission control (e.g., HARQ transmission processing), and transmission processing such as scheduling, transmission format selection, channel coding, Inverse Fast Fourier Transform (IFFT) processing, and precoding processing on the downlink data, and transfers the downlink data to each transmitting/receiving section 103. Furthermore, the baseband signal processing section 104 performs transmission processing such as channel coding and inverse fast Fourier transform on a downlink control signal, too, and transfers the downlink control signal to each transmitting/receiving section 103.

Each transmitting/receiving section 103 converts a baseband signal precoded and output per antenna from the baseband signal processing section 104 into a radio frequency range, and transmits a radio frequency signal. The radio frequency signal subjected to frequency conversion by each transmitting/receiving section 103 is amplified by each amplifying section 102, and is transmitted from each transmission/reception antenna 101. The transmitting/receiving sections 103 can be composed of transmitters/receivers, transmission/reception circuits or transmission/reception apparatuses described based on a common knowledge in a technical field according to the present invention. In this regard, the transmitting/receiving sections 103 may be composed as an integrated transmitting/receiving section or may be composed of transmitting sections and receiving sections.

Meanwhile, each amplifying section 102 amplifies a radio frequency signal received by each transmission/reception antenna 101 as an uplink signal. Each transmitting/receiving section 103 receives the uplink signal amplified by each amplifying section 102. Each transmitting/receiving section 103 performs frequency conversion on the received signal into a baseband signal, and outputs the baseband signal to the baseband signal processing section 104.

The baseband signal processing section 104 performs Fast Fourier Transform (FFT) processing, Inverse Discrete Fourier Transform (IDFT) processing, error correcting decoding, MAC retransmission control reception processing, and reception processing of an RLC layer and a PDCP layer on user data included in the input uplink signal, and transfers the user data to the higher station apparatus 30 via the communication path interface 106. The call processing section 105 performs call processing such as a configuration and release of a communication channel, state management of the radio base station 10 and radio resource management.

The communication path interface 106 transmits and receives signals to and from the higher station apparatus 30 via a given interface. Furthermore, the communication path interface 106 may transmit and receive (backhaul signaling) signals to and from the another radio base station 10 via an inter-base station interface (e.g., optical fibers compliant with the Common Public Radio Interface (CPRI) or the X2 interface).

In addition, each transmitting/receiving section 103 transmits a downlink signal (e.g., a downlink control signal (downlink control channel), a downlink data signal (a downlink data channel or a downlink shared channel), a downlink reference signal (a DM-RS or a CSI-RS), a discovery signal, a synchronization signal or a broadcast signal), and receives an uplink signal (e.g., an uplink control signal (uplink control channel), an uplink data signal (an uplink data channel or an uplink shared channel) or an uplink reference signal).

Furthermore, each transmitting/receiving section 103 may transmit a plurality of transmission request signals (e.g., beams) by respectively using a plurality of precoding based on a listening result of a first frequency range (e.g., unlicensed CC). Furthermore, each transmitting/receiving section 103 may receive a response signal (e.g., RTS response signal) based on received quality of a plurality of transmission request signals.

Furthermore, each transmitting/receiving section 103 may receive a plurality of transmission request signals (e.g., RTSs) transmitted by respectively using a plurality of precoding (e.g., beams) based on a listening result of the first frequency range (e.g., unlicensed CC). Furthermore, each transmitting/receiving section 103 may transmit a response signal (e.g., RTS response signal) based on the received quality of a plurality of transmission request signals.

The transmitting sections and the receiving sections according to the present invention are composed of the transmitting/receiving sections 103 and/or the communication path interface 106.

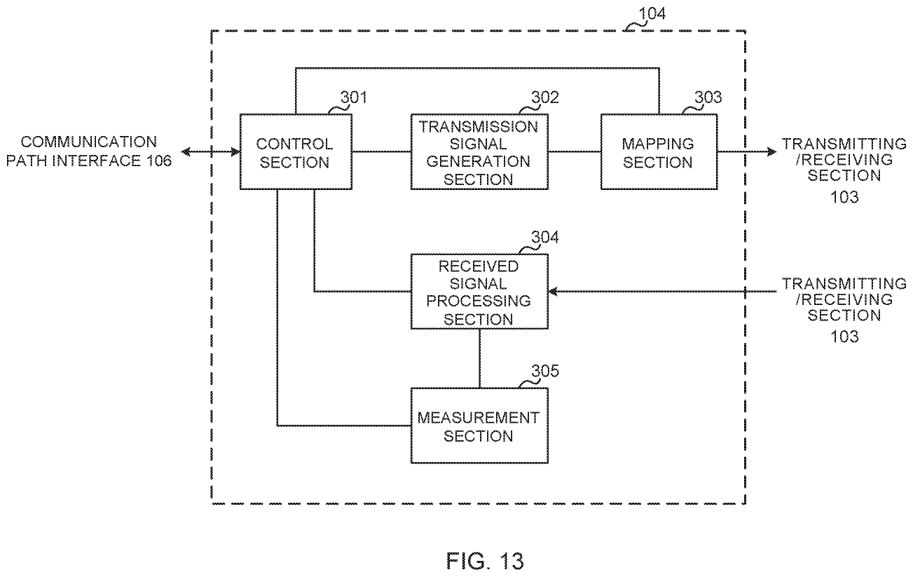

FIG. 13 is a diagram illustrating one example of a function configuration of the radio base station according to the present embodiment. In addition, FIG. 13 mainly illustrates function blocks of characteristic portions according to the present embodiment, and assumes that the radio base station 10 includes other function blocks, too, that are necessary for radio communication. As illustrated in FIG. 13, the baseband signal processing section 104 includes at least a control section 301, a transmission signal generating section 302, a mapping section 303, a received signal processing section 304 and a measurement section 305.

The control section 301 controls the entire radio base station 10. The control section 301 can be composed of a controller, a control circuit or a control apparatus described based on the common knowledge in the technical field according to the present invention.

The control section 301 controls, for example, signal generation of the transmission signal generating section 302 and signal allocation of the mapping section 303. Furthermore, the control section 301 controls signal reception processing of the received signal processing section 304 and signal measurement of the measurement section 305.

The control section 301 controls scheduling (e.g., resource allocation) of the downlink signal and/or the uplink signal. More specifically, the control section 301 controls the transmission signal generating section 302, the mapping section 303 and each transmitting/receiving section 103 to generate and transmit DCI (a DL assignment or a DL grant) including scheduling information of a downlink data channel and DCI (UL grant) including scheduling information of an uplink data channel.

Furthermore, the control section 301 may control reception of data transmitted by using precoding (e.g., a beam associated with the best received quality) determined based on a response signal (e.g., RTS response signal) among a plurality of precoding (e.g., beams) in the first frequency range (e.g., unlicensed CC).

Furthermore, the response signal may include at least one of identification information related to the transmission request signal (e.g., RTS) associated with the best received quality, and the received quality of each of a plurality of transmission request signals.

Furthermore, a plurality of transmission request signals may include different pieces of identification information (e.g., beam identifiers, RTS identifiers, SS block indices associated with beams and CRIs associated with the beams).

Furthermore, a plurality of transmission request signals may be transmitted in the first frequency range (e.g., unlicensed CC). Listening may be requested in the first frequency range before transmission. The response signal may be transmitted in a second frequency range (e.g., licensed CC). Listening may not be requested in the second frequency range before transmission.

Furthermore, the control section 301 may control transmission of data in the first frequency range by using the precoding determined based on the response signal among a plurality of precoding.

The transmission signal generating section 302 generates a downlink signal (such as a downlink control channel, a downlink data channel or a downlink reference signal such as a DM-RS) based on an instruction from the control section 301, and outputs the downlink signal to the mapping section 303. The transmission signal generating section 302 can be composed of a signal generator, a signal generating circuit or a signal generating apparatus described based on the common knowledge in the technical field according to the present invention.

The mapping section 303 maps the downlink signal generated by the transmission signal generating section 302, on given radio resources based on the instruction from the control section 301, and outputs the downlink signal to each transmitting/receiving section 103. The mapping section 303 can be composed of a mapper, a mapping circuit or a mapping apparatus described based on the common knowledge in the technical field according to the present invention.

The received signal processing section 304 performs reception processing (e.g., demapping, demodulation and decoding) on a received signal input from each transmitting/receiving section 103. In this regard, the received signal is, for example, an uplink signal (such as an uplink control channel, an uplink data channel or an uplink reference signal) transmitted from the user terminal 20. The received signal processing section 304 can be composed of a signal processor, a signal processing circuit or a signal processing apparatus described based on the common knowledge in the technical field according to the present invention.

The received signal processing section 304 outputs information decoded by the reception processing to the control section 301. For example, the received signal processing section 304 outputs at least one of a preamble, control information and uplink data to the control section 301. Furthermore, the received signal processing section 304 outputs the received signal and the signal after the reception processing to the measurement section 305.

The measurement section 305 performs measurement related to the received signal. The measurement section 305 can be composed of a measurement instrument, a measurement circuit or a measurement apparatus described based on the common knowledge in the technical field according to the present invention.

The measurement section 305 may measure, for example, received power (e.g., Reference Signal Received Power (RSRP)), received quality (e.g., Reference Signal Received Quality (RSRQ)) or a channel state of the received signal. The measurement section 305 may output a measurement result to the control section 301.

<User Terminal>

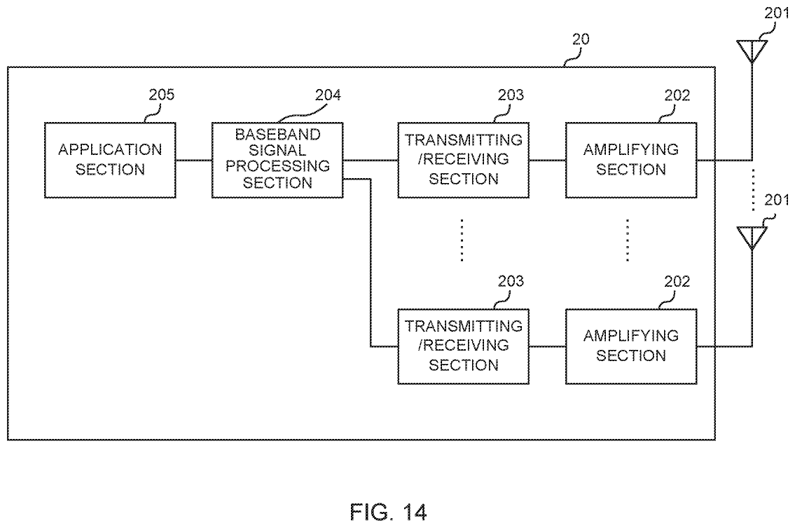

FIG. 14 is a diagram illustrating one example of an overall configuration of the user terminal according to the present embodiment. The user terminal 20 includes pluralities of transmission/reception antennas 201, amplifying sections 202 and transmitting/receiving sections 203, a baseband signal processing section 204 and an application section 205. In this regard, the user terminal 20 only needs to be configured to include one or more of each of the transmission/reception antennas 201, the amplifying sections 202 and the transmitting/receiving sections 203. The user terminal 20 may be a reception apparatus of downlink data and a transmission apparatus of uplink data.

Each amplifying section 202 amplifies a radio frequency signal received at each transmission/reception antenna 201. Each transmitting/receiving section 203 receives a downlink signal amplified by each amplifying section 202. Each transmitting/receiving section 203 performs frequency conversion on the received signal into a baseband signal, and outputs the baseband signal to the baseband signal processing section 204. The transmitting/receiving sections 203 can be composed of transmitters/receivers, transmission/reception circuits or transmission/reception apparatuses described based on the common knowledge in the technical field according to the present invention. In this regard, the transmitting/receiving sections 203 may be composed as an integrated transmitting/receiving section or may be composed of transmitting sections and receiving sections.

The baseband signal processing section 204 performs FFT processing, error correcting decoding and retransmission control reception processing on the input baseband signal. The baseband signal processing section 204 transfers downlink data to the application section 205. The application section 205 performs processing related to layers higher than a physical layer and an MAC layer. Furthermore, the baseband signal processing section 204 may transfer system information and higher layer control information of the downlink data, too, to the application section 205.

On the other hand, the application section 205 inputs uplink data to the baseband signal processing section 204. The baseband signal processing section 204 performs retransmission control transmission processing (e.g., HARQ transmission processing), channel coding, precoding, Discrete Fourier Transform (DFT) processing and IFFT processing on the uplink data, and transfers the uplink data to each transmitting/receiving section 203. Each transmitting/receiving section 203 converts the baseband signal output from the baseband signal processing section 204 into a radio frequency range, and transmits a radio frequency signal. The radio frequency signal subjected to the frequency conversion by each transmitting/receiving section 203 is amplified by each amplifying section 202, and is transmitted from each transmission/reception antenna 201.

In addition, each transmitting/receiving section 203 receives the downlink signal (e.g., the downlink control signal (downlink control channel), the downlink data signal (the downlink data channel or the downlink shared channel), the downlink reference signal (the DM-RS or the CSI-RS), the discovery signal, the synchronization signal or the broadcast signal), and transmits the uplink signal (e.g., the uplink control signal (uplink control channel), the uplink data signal (the uplink data channel or the uplink shared channel) or the uplink reference signal).

Furthermore, each transmitting/receiving section 203 may receive a plurality of transmission request signals (e.g., RTSs) transmitted by respectively using a plurality of precoding (e.g., beams) based on a listening result of the first frequency range (e.g., unlicensed CC). Furthermore, each transmitting/receiving section 203 may transmit a response signal (e.g., RTS response signal) based on the received quality of a plurality of transmission request signals.

Furthermore, each transmitting/receiving section 203 may transmit a plurality of transmission request signals (e.g., beams) transmitted by respectively using a plurality of precoding based on the listening result of the first frequency range (e.g., unlicensed CC). Furthermore, each transmitting/receiving section 203 may receive the response signal (e.g., RTS response signal) based on the received quality of a plurality of transmission request signals.

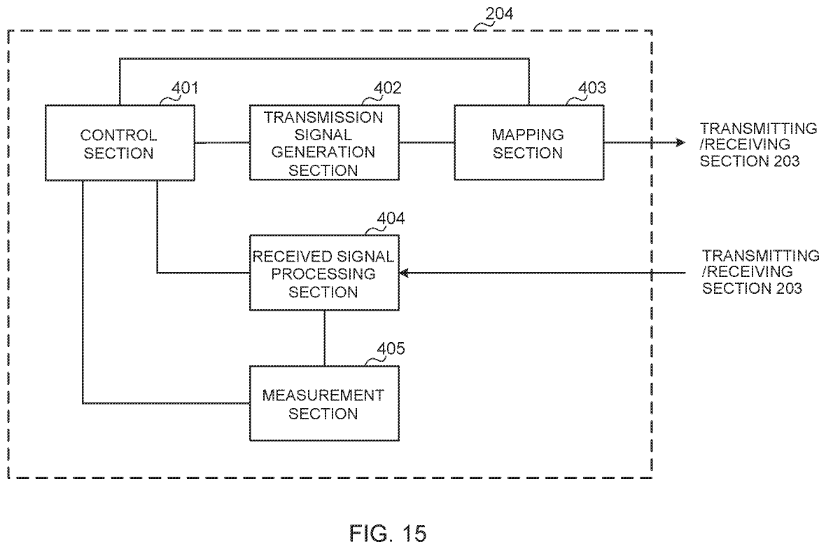

FIG. 15 is a diagram illustrating one example of a function configuration of the user terminal according to the present embodiment. In addition, FIG. 15 mainly illustrates function blocks of characteristic portions according to the present embodiment, and assumes that the user terminal 20 includes other function blocks, too, that are necessary for radio communication. As illustrated in FIG. 15, the baseband signal processing section 204 of the user terminal 20 includes at least a control section 401, a transmission signal generating section 402, a mapping section 403, a received signal processing section 404 and a measurement section 405.

The control section 401 controls the entire user terminal 20. The control section 401 can be composed of a controller, a control circuit or a control apparatus described based on the common knowledge in the technical field according to the present invention.

The control section 401 controls, for example, signal generation of the transmission signal generating section 402 and signal allocation of the mapping section 403. Furthermore, the control section 401 controls signal reception processing of the received signal processing section 404 and signal measurement of the measurement section 405.

Furthermore, the control section 401 may control reception of the data transmitted by using the precoding (e.g., the beam associated with the best received quality) determined based on the response signal (e.g., RTS response signal) among a plurality of precoding (e.g., beams) in the first frequency range (e.g., unlicensed CC).

Furthermore, the response signal may include at least one of the identification information related to the transmission request signal (e.g., RTS) associated with the best received quality, and the received quality of each of a plurality of transmission request signals.

Furthermore, a plurality of transmission request signals may include different pieces of identification information (e.g., beam identifiers, RTS identifiers, SS block indices associated with beams and CRIs associated with the beams).

Furthermore, a plurality of transmission request signals may be transmitted in the first frequency range (e.g., unlicensed CC). Listening may be requested in the first frequency range before transmission. The response signal may be transmitted in the second frequency range (e.g., licensed CC). Listening may not be requested in the second frequency range before transmission.

Furthermore, the control section 401 may control transmission of the data in the first frequency range by using the precoding determined based on the response signal among a plurality of precoding.

The transmission signal generating section 402 generates an uplink signal (such as an uplink control channel, an uplink data channel or an uplink reference signal) based on an instruction from the control section 401, and outputs the uplink signal to the mapping section 403. The transmission signal generating section 402 can be composed of a signal generator, a signal generating circuit or a signal generating apparatus described based on the common knowledge in the technical field according to the present invention.

The transmission signal generating section 402 generates an uplink data channel based on the instruction from the control section 401. When, for example, the downlink control channel notified from the radio base station 10 includes a UL grant, the transmission signal generating section 402 is instructed by the control section 401 to generate an uplink data channel.

The mapping section 403 maps the uplink signal generated by the transmission signal generating section 402, on radio resources based on the instruction from the control section 401, and outputs the uplink signal to each transmitting/receiving section 203. The mapping section 403 can be composed of a mapper, a mapping circuit or a mapping apparatus described based on the common knowledge in the technical field according to the present invention.

The received signal processing section 404 performs reception processing (e.g., demapping, demodulation and decoding) on the received signal input from each transmitting/receiving section 203. In this regard, the received signal is, for example, a downlink signal (such as a downlink control channel, a downlink data channel or a downlink reference signal) transmitted from the radio base station 10. The received signal processing section 404 can be composed of a signal processor, a signal processing circuit or a signal processing apparatus described based on the common knowledge in the technical field according to the present invention. Furthermore, the received signal processing section 404 can compose the receiving section according to the present invention.

The received signal processing section 404 blind-decodes the downlink control channel for scheduling at least one of transmission and reception of the downlink data channel based on an instruction of the control section 401, and performs reception processing on the downlink data channel based on the DCI. Furthermore, the received signal processing section 404 estimates a channel gain based on the DM-RS or the CRS, and demodulates the downlink data channel based on the estimated channel gain.

The received signal processing section 404 outputs information decoded by the reception processing to the control section 401. The received signal processing section 404 outputs, for example, broadcast information, system information, an RRC signaling and DCI to the control section 401. The received signal processing section 404 may output a data decoding result to the control section 401. Furthermore, the received signal processing section 404 outputs the received signal or the signal after the reception processing to the measurement section 405.

The measurement section 405 performs measurement related to the received signal. The measurement section 405 can be composed of a measurement instrument, a measurement circuit or a measurement apparatus described based on the common knowledge in the technical field according to the present invention.

The measurement section 405 may measure, for example, received power (e.g., RSRP), DL received quality (e.g., RSRQ) or a channel state of the received signal. The measurement section 405 may output a measurement result to the control section 401.

<Hardware Configuration>

In addition, the block diagrams used to describe the above embodiment illustrate blocks in function units. These function blocks (components) are realized by an optional combination of hardware and/or software. Furthermore, a method for realizing each function block is not limited in particular. That is, each function block may be realized by using one physically and/or logically coupled apparatus or may be realized by using a plurality of these apparatuses formed by connecting two or more physically and/or logically separate apparatuses directly and/or indirectly (by using, for example, wired connection and/or radio connection).

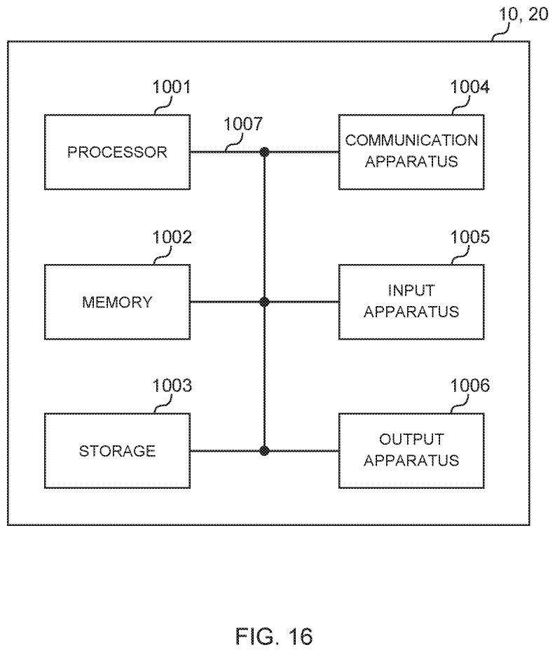

For example, the radio base station and the user terminal according to the one embodiment of the present invention may function as computers that perform processing of the radio communication method according to the present invention. FIG. 16 is a diagram illustrating one example of the hardware configurations of the radio base station and the user terminal according to the one embodiment of the present invention. The above-described radio base station 10 and user terminal 20 may be each physically configured as a computer apparatus that includes a processor 1001, a memory 1002, a storage 1003, a communication apparatus 1004, an input apparatus 1005, an output apparatus 1006 and a bus 1007.

In this regard, a word “apparatus” in the following description can be read as a circuit, a device or a unit. The hardware configurations of the radio base station 10 and the user terminal 20 may be configured to include one or a plurality of apparatuses illustrated in FIG. 16 or may be configured without including part of the apparatuses.

For example, FIG. 16 illustrates the only one processor 1001. However, there may be a plurality of processors. Furthermore, processing may be executed by 1 processor or processing may be executed by 1 or more processors concurrently or successively or by using another method. In addition, the processor 1001 may be implemented by 1 or more chips.

Each function of the radio base station 10 and the user terminal 20 is realized by, for example, causing hardware such as the processor 1001 and the memory 1002 to read given software (program), and thereby causing the processor 1001 to perform an operation, and control communication via the communication apparatus 1004 and control reading and/or writing of data in the memory 1002 and the storage 1003.

The processor 1001 causes, for example, an operating system to operate to control the entire computer. The processor 1001 may be composed of a Central Processing Unit (CPU) including an interface for a peripheral apparatus, a control apparatus, an operation apparatus and a register. For example, the above-described baseband signal processing section 104 (204) and call processing section 105 may be realized by the processor 1001.

Furthermore, the processor 1001 reads programs (program codes), a software module or data from the storage 1003 and/or the communication apparatus 1004 out to the memory 1002, and executes various types of processing according to these programs, software module or data. As the programs, programs that cause the computer to execute at least part of the operations described in the above-described embodiment are used. For example, the control section 401 of the user terminal 20 may be realized by a control program that is stored in the memory 1002 and operates on the processor 1001, and other function blocks may be also realized likewise.

The memory 1002 is a computer-readable recording medium, and may be composed of at least one of, for example, a Read Only Memory (ROM), an Erasable Programmable ROM (EPROM), an Electrically EPROM (EEPROM), a Random Access Memory (RAM) and other appropriate storage media. The memory 1002 may be referred to as a register, a cache or a main memory (main storage apparatus). The memory 1002 can store programs (program codes) and a software module that can be executed to perform the radio communication method according to the one embodiment of the present invention.

The storage 1003 is a computer-readable recording medium, and may be composed of at least one of, for example, a flexible disk, a floppy (registered trademark) disk, a magnetooptical disk (e.g., a compact disk (Compact Disc ROM (CD-ROM)), a digital versatile disk and a Blu-ray (registered trademark) disk), a removable disk, a hard disk drive, a smart card, a flash memory device (e.g., a card, a stick or a key drive), a magnetic stripe, a database, a server and other appropriate storage media. The storage 1003 may be referred to as an auxiliary storage apparatus.

The communication apparatus 1004 is hardware (transmission/reception device) that performs communication between computers via wired and/or radio networks, and will be also referred to as, for example, a network device, a network controller, a network card and a communication module. The communication apparatus 1004 may be configured to include a high frequency switch, a duplexer, a filter and a frequency synthesizer to realize, for example, Frequency Division Duplex (FDD) and/or Time Division Duplex (TDD). For example, the above-described transmission/reception antennas 101 (201), amplifying sections 102 (202), transmitting/receiving sections 103 (203) and communication path interface 106 may be realized by the communication apparatus 1004.

The input apparatus 1005 is an input device (e.g., a keyboard, a mouse, a microphone, a switch, a button or a sensor) that accepts an input from an outside. The output apparatus 1006 is an output device (e.g., a display, a speaker or a Light Emitting Diode (LED) lamp) that sends an output to the outside. In addition, the input apparatus 1005 and the output apparatus 1006 may be an integrated component (e.g., touch panel).

Furthermore, each apparatus such as the processor 1001 or the memory 1002 is connected by the bus 1007 that communicates information. The bus 1007 may be composed by using a single bus or may be composed by using different buses between apparatuses.

Furthermore, the radio base station 10 and the user terminal 20 may be configured to include hardware such as a microprocessor, a Digital Signal Processor (DSP), an Application Specific Integrated Circuit (ASIC), a Programmable Logic Device (PLD) and a Field Programmable Gate Array (FPGA). The hardware may be used to realize part or all of each function block. For example, the processor 1001 may be implemented by using at least one of these types of hardware.

### Modified Example

In addition, each term that has been described in this description and/or each term that is necessary to understand this description may be replaced with terms having identical or similar meanings. For example, a channel and/or a symbol may be signals (signalings). Furthermore, a signal may be a message. A reference signal can be also abbreviated as an RS (Reference Signal), or may be also referred to as a pilot or a pilot signal depending on standards to be applied. Furthermore, a Component Carrier (CC) may be referred to as a cell, a frequency carrier and a carrier frequency.

Furthermore, a radio frame may include one or a plurality of durations (frames) in a time domain. Each of one or a plurality of durations (frames) that composes a radio frame may be referred to as a subframe. Furthermore, the subframe may include one or a plurality of slots in the time domain. The subframe may be a fixed time duration (e.g., 1 ms) that does not depend on the numerologies.

Furthermore, the slot may include one or a plurality of symbols (Orthogonal Frequency Division Multiplexing (OFDM) symbols or Single Carrier-Frequency Division Multiple Access (SC-FDMA) symbols) in the time domain. Furthermore, the slot may be a time unit based on the numerologies. Furthermore, the slot may include a plurality of mini slots. Each mini slot may include one or a plurality of symbols in the time domain. Furthermore, the mini slot may be referred to as a subslot.

The radio frame, the subframe, the slot, the mini slot and the symbol each indicate a time unit for conveying signals. The other corresponding names may be used for the radio frame, the subframe, the slot, the mini slot and the symbol. For example, 1 subframe may be referred to as a Transmission Time Interval (TTI), a plurality of contiguous subframes may be referred to as TTIs, or 1 slot or 1 mini slot may be referred to as a TTI. That is, the subframe and/or the TTI may be a subframe (1 ms) according to legacy LTE, may be a duration (e.g., 1 to 13 symbols) shorter than 1 ms or may be a duration longer than 1 ms. In addition, a unit that indicates the TTI may be referred to as a slot or a mini slot instead of a subframe.

In this regard, the TTI refers to, for example, a minimum time unit of scheduling for radio communication. For example, in the LTE system, the radio base station performs scheduling for allocating radio resources (a frequency bandwidth or transmission power that can be used in each user terminal) in TTI units to each user terminal. In this regard, a definition of the TTI is not limited to this.

The TTI may be a transmission time unit of a channel-coded data packet (transport block), code block and/or codeword, or may be a processing unit of scheduling or link adaptation. In addition, when the TTI is given, a time period (e.g., the number of symbols) in which a transport block, a code block and/or a codeword are actually mapped may be shorter than the TTI.

In addition, when 1 slot or 1 mini slot is referred to as a TTI, 1 or more TTIs (i.e., 1 or more slots or 1 or more mini slots) may be a minimum time unit of scheduling. Furthermore, the number of slots (the number of mini slots) that compose a minimum time unit of the scheduling may be controlled.

The TTI having the time duration of 1 ms may be referred to as a general TTI (TTIs according to LTE Rel. 8 to 12), a normal TTI, a long TTI, a general subframe, a normal subframe or a long subframe. A TTI shorter than the general TTI may be referred to as a reduced TTI, a short TTI, a partial or fractional TTI, a reduced subframe, a short subframe, a mini slot or a subslot.

In addition, the long TTI (e.g., the general TTI or the subframe) may be read as a TTI having a time duration exceeding 1 ms, and the short TTI (e.g., the reduced TTI) may be read as a TTI having a TTI length less than the TTI length of the long TTI and equal to or more than 1 ms.

A Resource Block (RB) is a resource allocation unit of the time domain and the frequency domain, and may include one or a plurality of contiguous subcarriers in the frequency domain. Furthermore, the RB may include one or a plurality of symbols in the time domain or may have the length of 1 slot, 1 mini slot, 1 subframe or 1 TTI. 1 TTI or 1 subframe may each include one or a plurality of resource blocks. In this regard, one or a plurality of RBs may be referred to as a Physical Resource Block (PRB: Physical RB), a Sub-Carrier Group (SCG), a Resource Element Group (REG), a PRB pair or a RB pair.

Furthermore, the resource block may include one or a plurality of Resource Elements (REs). For example, 1 RE may be a radio resource domain of 1 subcarrier and 1 symbol.

In this regard, structures of the above-described radio frame, subframe, slot, mini slot and symbol are only exemplary structures. For example, configurations such as the number of subframes included in a radio frame, the number of slots per subframe or radio frame, the number of mini slots included in a slot, the numbers of symbols and RBs included in a slot or a mini slot, the number of subcarriers included in an RB, the number of symbols in a TTI, a symbol length and a Cyclic Prefix (CP) length can be variously changed.

Furthermore, the information and parameters described in this description may be expressed by using absolute values, may be expressed by using relative values with respect to given values or may be expressed by using other corresponding information. For example, a radio resource may be instructed by a given index.

Names used for parameters in this description are in no respect restrictive names. For example, various channels (the Physical Uplink Control Channel (PUCCH) and the Physical Downlink Control Channel (PDCCH)) and information elements can be identified based on various suitable names. Therefore, various names assigned to these various channels and information elements are in no respect restrictive names.

The information and the signals described in this description may be expressed by using one of various different techniques. For example, the data, the instructions, the commands, the information, the signals, the bits, the symbols and the chips mentioned in the above entire description may be expressed as voltages, currents, electromagnetic waves, magnetic fields or magnetic particles, optical fields or photons, or optional combinations of these.

Furthermore, the information and the signals can be output from a higher layer to a lower layer and/or from the lower layer to the higher layer. The information and the signals may be input and output via a plurality of network nodes.

The input and output information and signals may be stored in a specific location (e.g., memory) or may be managed by using a management table. The information and signals to be input and output can be overwritten, updated or additionally written. The output information and signals may be deleted. The input information and signals may be transmitted to other apparatuses.

Notification of information is not limited to the aspects/embodiment described in this description and may be performed by using other methods. For example, the information may be notified by a physical layer signaling (e.g., Downlink Control Information (DCI) and Uplink Control Information (UCI)), a higher layer signaling (e.g., a Radio Resource Control (RRC) signaling, broadcast information (a Master Information Block (MIB) and a System Information Block (SIB)), and a Medium Access Control (MAC) signaling), other signals or combinations of these.

In addition, the physical layer signaling may be referred to as Layer 1/Layer 2 (L1/L2) control information (L1/L2 control signal) or L1 control information (L1 control signal). Furthermore, the RRC signaling may be referred to as an RRC message, and may be, for example, an RRCConnectionSetup message or an RRCConnectionReconfiguration message. Furthermore, the MAC signaling may be notified by using, for example, an MAC Control Element (MAC CE).

Furthermore, notification of given information (e.g., notification of “being X”) is not limited to explicit notification, and may be given implicitly (by, for example, not giving notification of the given information or by giving notification of another information).

Decision may be made based on a value (0 or 1) expressed as 1 bit, may be made based on a boolean expressed as true or false or may be made by comparing numerical values (by, for example, making comparison with a given value).

Irrespectively of whether software is referred to as software, firmware, middleware, a microcode or a hardware description language or is referred to as other names, the software should be widely interpreted to mean a command, a command set, a code, a code segment, a program code, a program, a subprogram, a software module, an application, a software application, a software package, a routine, a subroutine, an object, an executable file, an execution thread, a procedure or a function.

Furthermore, software, commands and information may be transmitted and received via transmission media. When, for example, the software is transmitted from websites, servers or other remote sources by using wired techniques (e.g., coaxial cables, optical fiber cables, twisted pairs and Digital Subscriber Lines (DSLs)) and/or radio techniques (e.g., infrared rays and microwaves), these wired techniques and/or radio techniques are included in a definition of the transmission media.

The terms “system” and “network” used in this description can be interchangeably used.

In this description, the terms “Base Station (BS)”, “radio base station”, “eNB”, “gNB”, “cell”, “sector”, “cell group”, “carrier” and “component carrier” can be interchangeably used. The base station will be also referred to as a term such as a fixed station, a NodeB, an eNodeB (eNB), an access point, a transmission point, a reception point, a transmission and reception point, a femtocell or a small cell in some cases.

The base station can accommodate one or a plurality of (e.g., three) cells (also referred to as sectors). When the base station accommodates a plurality of cells, an entire coverage area of the base station can be partitioned into a plurality of smaller areas. Each smaller area can also provide a communication service via a base station subsystem (e.g., indoor small base station (RRH: Remote Radio Head)). The term “cell” or “sector” indicates part or the entirety of the coverage area of the base station and/or the base station subsystem that provide a communication service in this coverage.

In this description, the terms “Mobile Station (MS)”, “user terminal”, “user apparatus (UE: User Equipment)” and “terminal” can be interchangeably used.

The mobile station will be also referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or some other appropriate terms in some cases.

The base station and/or the mobile station may be referred to as a transmission apparatus and a reception apparatus.

Furthermore, the radio base station in this description may be read as the user terminal. For example, each aspect/embodiment of the present invention may be applied to a configuration where communication between the radio base station and the user terminal is replaced with communication between a plurality of user terminals (D2D: Device-to-Device). In this case, the user terminal 20 may be configured to include the functions of the above-described radio base station 10. Furthermore, words such as “uplink” and “downlink” may be read as a “side”. For example, the uplink channel may be read as a side channel.

Similarly, the user terminal in this description may be read as the radio base station. In this case, the radio base station 10 may be configured to include the functions of the above-described user terminal 20.

In this description, operations performed by the base station are performed by an upper node of this base station depending on cases. Obviously, in a network including one or a plurality of network nodes including the base stations, various operations performed to communicate with a terminal can be performed by base stations, one or more network nodes (that are supposed to be, for example, Mobility Management Entities (MMEs) or Serving-Gateways (S-GWs) yet are not limited to these) other than the base stations or a combination of these.

Each aspect/embodiment described in this description may be used alone, may be used in combination or may be switched and used when carried out. Furthermore, orders of the processing procedures, the sequences and the flowchart according to each aspect/embodiment described in this description may be rearranged unless contradictions arise. For example, the method described in this description presents various step elements in an exemplary order and is not limited to the presented specific order.

Each aspect/embodiment described in this description may be applied to Long Term Evolution (LTE), LTE-Advanced (LTE-A), LTE-Beyond (LTE-B), SUPER 3G, IMT-Advanced, the 4th generation mobile communication system (4G), the 5th generation mobile communication system (5G), Future Radio Access (FRA), the New Radio Access Technology (New-RAT), New Radio (NR), New radio access (NX), Future generation radio access (FX), Global System for Mobile communications (GSM) (registered trademark), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other appropriate radio communication methods and/or next-generation systems that are expanded based on these systems.

The phrase “based on” used in this description does not mean “based only on” unless specified otherwise. In other words, the phrase “based on” means both of “based only on” and “based at least on”.

Every reference to elements that use names such as “first” and “second” used in this description does not generally limit the quantity or the order of these elements. These names can be used in this description as a convenient method for distinguishing between two or more elements. Hence, the reference to the first and second elements does not mean that only two elements can be employed or the first element should precede the second element in some way.

The term “deciding (determining)” used in this description includes diverse operations in some cases. For example, “deciding (determining)” may be regarded to “decide (determine)” calculating, computing, processing, deriving, investigating, looking up (e.g., looking up in a table, a database or another data structure) and ascertaining. Furthermore, “deciding (determining)” may be regarded to “decide (determine)” receiving (e.g., receiving information), transmitting (e.g., transmitting information), input, output and accessing (e.g., accessing data in a memory). Furthermore, “deciding (determining)” may be regarded to “decide (determine)” resolving, selecting, choosing, establishing and comparing. That is, “deciding (determining)” may be regarded to “decide (determine)” some operation.

The words “connected” and “coupled” used in this description or every modification of these words can mean every direct or indirect connection or coupling between 2 or more elements, and can include that 1 or more intermediate elements exist between the two elements “connected” or “coupled” with each other. The elements may be coupled or connected physically or logically or by a combination of these physical and logical connections. For example, “connection” may be read as “access”.

It can be understood in this description that, when connected, the two elements are “connected” or “coupled” with each other by using 1 or more electric wires, cables and/or printed electrical connection, and by using electromagnetic energy having wavelengths in radio frequency domains, microwave domains and/or (both of visible and invisible) light domains in some non-restrictive and non-comprehensive examples.

A sentence that “A and B are different” in this description may mean that “A and B are different from each other”. Words such as “separate” and “coupled” may be also interpreted in a similar manner.

When the words “including” and “comprising” and modifications of these words are used in this description or the claims, these words intend to be comprehensive similar to the word “having”. Furthermore, the word “or” used in this description or the claims intends not to be an exclusive OR.

The present invention has been described in detail above. However, it is obvious for a person skilled in the art that the present invention is not limited to the embodiment described in this description. The present invention can be carried out as modified and changed aspects without departing from the gist and the scope of the present invention defined based on the recitation of the claims. Accordingly, the disclosure of this description is intended for exemplary explanation, and does not bring any restrictive meaning to the present invention.

1. A reception apparatus comprising:
a receiving section that receives a plurality of transmission request signals that have been transmitted by respectively using a plurality of precoding based on a listening result of a first frequency range;
a transmitting section that transmits a response signal that is based on received quality of the plurality of transmission request signals; and
a control section that controls reception of data transmitted in the first frequency range by using precoding determined based on the response signal among the plurality of precoding.

2. The reception apparatus according to claim 1, wherein the response signal includes at least one of identification information related to a transmission request signal associated with best received quality, and received quality of each of the plurality of transmission request signals.

3. The reception apparatus according to claim 2, wherein the plurality of transmission request signals include different pieces of identification information.

4. The reception apparatus according to claim 1, wherein the plurality of transmission request signals are transmitted in the first frequency range, listening is requested in the first frequency range before transmission, the response signal is transmitted in a second frequency range, and listening is not requested in the second frequency range before transmission.

5. A transmission apparatus comprising:
a transmitting section that transmits a plurality of transmission request signals by respectively using a plurality of precoding based on a listening result of a first frequency range;
a receiving section that receives a response signal that is based on received quality of the plurality of transmission request signals; and
a control section that controls transmission of data in the first frequency range by using precoding determined based on the response signal among the plurality of precoding.

6. A radio communication method comprising:
receiving a plurality of transmission request signals that have been transmitted by respectively using a plurality of precoding based on a listening result of a first frequency range;
transmitting a response signal that is based on received quality of the plurality of transmission request signals; and
controlling reception of data transmitted in the first frequency range by using precoding determined based on the response signal among the plurality of precoding.

7. The reception apparatus according to claim 2, wherein the plurality of transmission request signals are transmitted in the first frequency range, listening is requested in the first frequency range before transmission, the response signal is transmitted in a second frequency range, and listening is not requested in the second frequency range before transmission.

8. The reception apparatus according to claim 3, wherein the plurality of transmission request signals are transmitted in the first frequency range, listening is requested in the first frequency range before transmission, the response signal is transmitted in a second frequency range, and listening is not requested in the second frequency range before transmission.
